(19) United States
(12) Patent Application Publication
(10) Pub. No.: US 2006/0278532 A1
(43) Pub. Date: Dec. 14, 2006

(54) Assay for neuromuscular diseases

(75) Inventors: Ira Leonard Goldknopf, The Woodlands, TX (US); Essam Ahmed Sheta, The Woodlands, TX (US); Stanley H. Appel, Houston, TX (US); Jennifer K. Bryson, The Woodlands, TX (US); Lemuel Moye, Houston, TX (US); Albert Yen, Houston, TX (US); Brian R. Folsom, Chaska, MN (US); Miguel Mosqueda, Willis, TX (US)

Correspondence Address: Power3 Medical Products, Inc.;Ira L. Goldknopf, Ph.D., 3400 Research Forest Drive, The Woodlands, TX, 77381, US

(73) Assignee: Power3 Medical Products, Inc., The Woodlands, TX (US)

(21) Appl. No.: 11/411,659

(22) Filed: Apr. 26, 2006

Related U.S. Application Data
(60) Provisional application No. 60/676,732, filed on May 2, 2005.

(51) Int. Cl. G01N 27/26

(52) U.S. Cl. 204/601

(57) ABSTRACT

The present invention is an assay for determining if a patient has a neuromuscular disease. The method comprises collecting a biological sample from a patient, separating the proteins present in the biological sample, quantitating a panel of proteins by proteomic techniques, analyzing the quantity of the protein panel using biostatistics, and determining whether or not the patient has a neuromuscular disease based on the statistical analysis of the results.

### CROSS REFERENCE TO RELATED APPLICATIONS

This application claims priority to U.S. Provisional Patent application Ser. No. 60/676,732 filed May 2, 2005 and entitled “Assay For Neuromuscular Diseases” by inventors Ira L. Goldknopf, et. al.

### BACKGROUND OF THE INVENTION

1. Field of the Invention

The invention relates to a method for discriminating between control patients and patients with neuromuscular disorders such as amyotrophic lateral sclerosis (ALS), ALS-like diseases, Parkinson's (PD), and PD-like diseases. The method is based on the use of 2-dimensional (2D) gel electrophoresis to separate the complex mixture of proteins found in blood serum and the quantitation of a group of identified biomarkers to differentiate normal patients from patients having neuromuscular diseases.

2. Description of the Related Art

Proteomics is a new field of medical research wherein proteins are identified and linked to biological functions, including roles in a variety of disease states. With the completion of the mapping of the human genome, the identification of unique gene products, or proteins, has increased exponentially. In addition, molecular diagnostic testing for the presence of certain proteins already known to be involved in certain biological functions has progressed from research applications alone to use in disease screening and diagnosis for clinicians. However, proteomic testing for diagnostic purposes remains in its infancy. There is, however, a great deal of interest in using proteomics for the elucidation of potential disease biomarkers.

Detection of abnormalities in the genome of an individual can reveal the risk or potential risk for individuals to develop a disease. The transition from risk to emergence of disease can be characterized as an expression of genomic abnormalities in the proteome. Thus, the appearance of abnormalities in the proteome signals the beginning of the process of cascading effects that can result in the deterioration of the health of the patient. Therefore, detection of proteomic abnormalities at an early stage is desired in order to allow for detection of disease either before it is established or in its earliest stages where treatment may be effective.

Recent progress using a novel form of mass spectrometry called surface enhanced laser desorption and ionization time of flight (SELDI-TOF) for the testing of ovarian cancer and Alzheimer's disease has led to an increased interest in proteomics as a diagnostic tool (Petrocoin, E. F. et al. 2002. Lancet 359:572-577; Lewczuk, P. et al. 2004. Biol. Psychiatry 55:524-530). Furthermore, proteomics has been applied to the study of breast cancer through use of 2D gel electrophoresis and image analysis to study the development and progression of breast carcinoma in patients and in plasma from Alzheimer's disease patients (Kuerer, H. M. et al. 2002. Cancer 95:2276-2282; Ueno, I. et al. 2000. Electrophoresis 21:1832-1845). In the case of breast cancer, breast ductal fluid specimens were used to identify distinct protein expression patterns in bilateral matched pair ductal fluid samples of women with unilateral invasive breast carcinoma.

Detection of biomarkers is an active field of research. For example, U.S. Pat. No. 5,958,785 discloses a biomarker for detecting long-term or chronic alcohol consumption. The biomarker disclosed is a single biomarker and is identified as an alcohol-specific ethanol glycoconjugate. U.S. Pat. No. 6,124,108 discloses a biomarker for mustard chemical injury. The biomarker is a specific protein band detected through gel electrophoresis and the patent describes use of the biomarker to raise protective antibodies or in a kit to identify the presence or absence of the biomarker in individuals who may have been exposed to mustard poisoning. U.S. Pat. No. 6,326,209 B1 discloses measurement of total urinary 17 ketosteroid-sulfates as biomarkers of biological age. U.S. Pat. No. 6,693,177 B1 discloses a process for preparation of a single biomarker specific for O-acetylated sialic acid and useful for diagnosis and outcome monitoring in patients with lymphoblastic leukemia.

Neurodegenerative diseases are difficult to diagnose, particularly in their early stages, as currently there are no biomarkers available for either the early diagnosis or treatment of neuromuscular diseases such as amyotrophic lateral sclerosis (ALS), ALS-like diseases, Parkinson's (PD) disease, or PD-like diseases.

Therefore, there remains a need for better ways to detect and distinguish ALS and other neuromuscular diseases from non-neuromuscular diseases.

### SUMMARY OF THE INVENTION

The present invention is an assay for determining if a patient has a neuromuscular disease. The method comprises collecting a biological sample from a patient, separating the proteins present in the biological sample, quantitating a panel of proteins by proteomic techniques, and determining whether or not the patient has a neuromuscular disease based on the statistical analysis of the quantity of the proteins in the protein panel present in the patient's serum.

One aspect of the present invention is a method for screening a patient for neuromuscular disease. The method includes: collecting a serum sample from a patient, separating the proteins in the serum sample by 2D gel electrophoresis, quantitating a panel of protein biomarkers, and determining whether or not the patient has a neuromuscular disease based on the quantity of the biomarkers in the patient's serum.

The foregoing has outlined rather broadly several aspects of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed might be readily utilized as a basis for modifying or redesigning the methods for carrying out the same purposes as the invention. It should be realized by those skilled in the art that such equivalent constructions do not depart from the spirit and scope of the invention as set forth in the appended claims.

### DESCRIPTION OF THE PREFERRED EMBODIMENTS

The present invention is an assay for determining if a patient has a neuromuscular disease. The method comprises collecting a biological sample from a patient, separating the proteins present in the biological sample, quantitating a panel of proteins by proteomic techniques, analyzing the quantity of the protein panel using biostatistics, and determining whether or not the patient has a neuromuscular disease based on the statistical analysis of the results.

In the context of the present invention a “neuromuscular disease” is a condition wherein an individual or patient exhibits a known set of symptoms such as limb weakness, slurred speech and/or muscle twitching and would include but not be limited to amyotrophic lateral sclerosis (ALS, also known as Lou Gehrig's disease), ALS-like diseases, Parkinson's disease (PD), and PD-like diseases.

In the context of the present invention a “ALS-like disease” would include but not be limited to benign fasciculations, brachial amyotrophic diplegia, brachial plexopathy, cervical myelopathy, lumbosacral radiculopathy, cervical radiculopathy, chronic inflammatory demyelinating polyradiculoneuropathy, diabetic neuropathy, cervical and lumbar stenosis, Guillain Barre syndrome—axonal type, inclusion body myositis, inflammatory peripheral neuropathy, inflammatory myelopathy with polyneuropathy, monomelic amyotrophy, multiple sclerosis, muscular dystrophy, myasthenia gravis, myotonic dystrophy, progressive bulbar palsy, progressive muscular atrophy, spinal bulbar muscular atrophy (Kennedy's disease), spinal muscular atrophy, and spinal cord syrinx with a history of spinal meningitis.

In the context of the present invention a “PD-like disease” would include but not be limited to Lewy body dementia, multiple system atrophy, idiopathic sensory ataxia, MSA, and CBGD.

In the context of the present invention, the “protein expression profile” corresponds to the steady state level of the various proteins in the biological samples that can be expressed quantitatively. These steady state levels are the result of the combination of all the factors that control protein concentration in a biological sample. These factors include but are not limited to: the rates of transcription of the genes encoding the hnRNAs; the rates of processing of the hnRNAs into mRNAs; the splicing variations during the processing of the hnRNAs into mRNAs which govern the relative amounts of the protein isoforms; the rates of processing of the various mRNAs by 3′-polyadenylation and 5′-capping; the rates of transport of the mRNAs to the sites of protein synthesis; the rate of translation of the mRNA's into the corresponding proteins; the rates of protein post-translational modifications, including but not limited to phosphorylation, nitrosylation, methylation, acetylation, glycosylation, poly-ADP-ribosylation, ubiquitinylation, and conjugation with ubiquitin like proteins; the rates of protein turnover via the ubiquitin-proteosome system; the rates of intracellular transport of the proteins among compartments such as but not limited to the nucleus, the lysosomes, golgi, the membrane, and the mitochondrion; the rates of secretion of the proteins into the interstitial space; the rates of secretion related protein processing; and the stability and rates of processing and degradation of the proteins in the biological sample before and after the sample is taken from the patient.

A “control” or “normal” sample is a sample, preferably a serum sample, taken from an individual with no known disease, particularly without a neuromuscular disease.

The method of the present invention is based on the quantity of specified proteins. Preferably the proteins are separated and identified by 2D gel electrophoresis. 2D gel electrophoresis has been used in research laboratories for biomarker discovery since the 1970's (Orrick, L. R. et al. 1973. Proc. Natl. Sci. U.S.A. 70:1316-1320; Goldknopf, I. L. et al. 1975. J. Biol Chem. 250:71282-7187; O'Farrell, P. et al. 1975. J. Biol. Chem. May 250:4007-4021; Anderson, L. and Anderson, N. G. 1977. Proc. Natl. Acad. Sci. U.S.A. 74:5421-5425; Goldknopf, I. L. and Busch, H. 1977. Proc. Natl. Acad. Sci. USA 74:864-868). In the past, this method has been considered highly specialized, labor intensive and non-reproducible.

Only recently with the advent of integrated supplies, robotics, and software combined with bioinformatics has progression of this proteomics technique in the direction of diagnostics become feasible. The promise and utility of 2D gel electrophoresis is based on its ability to detect changes in protein expression and to discriminate protein isoforms that arise due to variations in amino acid sequence and/or post-synthetic protein modifications such as phosphorylation, ubiquitination, conjugation with ubiquitin-like proteins, acetylation, and glycosylation. These are important variables in cell regulatory processes involved in cancer and other diseases.

There are few comparable alternatives to 2D gels for tracking changes in protein expression patterns related to disease progression. The introduction of high sensitivity fluorescent staining, digital image processing and computerized image analysis has greatly amplified and simplified the detection of unique species and the quantification of proteins. By using known protein standards as landmarks within each gel run, computerized analysis can detect unique differences in protein expression and modifications between two samples from the same individual or between several individuals.

Sample Collection and Preparation

Serum samples were prepared from blood acquired by venipuncture. The blood was centrifuged at 500×g for 10 minutes, and the separated serum was divided into aliquots, and frozen at 40° C. or below until shipment. Samples were shipped on dry ice and were delivered within 24 hours of shipping.

Once the serum samples were received, logged in, and assigned a sample number, they were further processed in preparation for 2-D gel electrophoresis. All samples were stored at −40° C. or below. When the serum samples were removed from storage, they were placed on ice for thawing and kept on ice for further processing.

To each 100 μl of sample, 100 μl of LB-2 buffer (SM urea, 2M Thiourea, 0.5% ASB-14, 0.25% CHAPS, 0.25% Tween-20, 5% glycerol, 100 mM DTT, 1× Protease inhibitors, and 1× Ampholyte pH 3-10) was added and the mixture vortexed. The sample was incubated at room temperature for about 5 minutes.

Separation of Proteins in Patient Samples

The proteins in the patient and control samples were separated using various techniques known in the art for separating proteins, techniques that include but gel filtration chromatography, ion exchange chromatograph, reverse phase chromatography, affinity chromatography, or any of the various centrifugation techniques well known in the art. In some cases, a combination of one or more chromatography or centrifugation steps may be combined via electrospray or nanospray with mass spectroscopy or tandem mass spectroscopy, or any protein separation technique that determines the pattern of proteins in a mixture either as a one-dimensional, two-dimensional, three-dimensional or multi-dimensional pattern or list of proteins present.

Two Dimensional-Electrophoresis of Samples

Preferably the protein profiles of the present invention are obtained by subjecting biological samples to two-dimensional (2D) gel electrophoresis to separate the proteins in the biological sample into a two-dimensional array of protein spots.

Two-dimensional gel electrophoresis is a useful technique for separating complex mixtures of proteins and can be performed using a variety of methods known in the art (see, e.g., U.S. Pat. Nos. 5,534,121 and 6,398,933 and U.S. Patent Application Nos. 2003/0077832 and 2003/0211624 A1).

In certain embodiments, the first dimensional gel is an isoelectric focusing gel and the second gel is a denaturing polyacrylamide gradient gel.

Proteins are amphoteric, containing both positive and negative charges and like all ampholytes exhibit the property that their charge depends on pH. At low pH, proteins are positively charged while at high pH they are negatively charged. For every protein there is a pH at which it is uncharged, or the isoelectric point. When a charged molecule is placed in an electric field it will migrate towards the opposite charge. In a pH gradient such as those used in the present invention, a protein will migrate to the point at which it reaches its isoelectric point and becomes uncharged. The uncharged protein will not migrate further and stops. Each protein will stop at its isoelectric point and the proteins can thus be separated according to charge. In order to achieve optimal separation of proteins, various pH gradients may be used. For example, a very broad range of pH, from about 3 to 11 or 3 to 10 can be used, or a more narrow range, such as from pH 4 to 7 or 7 to 10 or 6 to 11 can be used. The choice of pH range is determined empirically and such determinations are within the skill of the ordinary practitioner and can be accomplished without undue experimentation.

In the second dimension, proteins are separated according to molecular weight by measuring mobility through a polyacrylamide gradient in the detergent sodium dodecyl sulfate (SDS). In the presence of SDS and a reducing agent such as dithiothreitol (DTT), the proteins act as though they are of uniform shape with the same charge to mass ratio. The proteins are then separated by molecular weight on the gel. It is well known in the art that various concentration gradients of acrylamide may be used for such protein separations. For example, a gradient of from about 5% to 20% may be used in certain embodiments or any other gradient that achieves a satisfactory separation of proteins in the sample may be used. Other gradients would include but not be limited to from about 5 to 18%, 6 to 20%, 8 to 20%, 8 to 18%, 8 to 16%, 10 to 16%, or any range as determined by one of skill.

Separation of Proteins in Serum Samples

Separation of the proteins in a set of neuromuscular patient and control serum samples was performed using 2D gel electrophoresis.

An appropriate amount of isoelectric focusing (IEF) loading buffer (LB-2), was added to the diluted serum sample, incubated at room temperature and vortexed periodically until the pellet was dissolved to visual clarity. The samples were centrifuged briefly before a protein assay was performed on the sample.

Approximately 100 μg of the solubilized protein pellet was suspended in a total volume of 184 μl of IEF loading buffer and 1 μl Bromophenol Blue. Each sample was loaded onto an 11 cm IEF strip (Bio-Rad), pH 5-8, and overlaid with 1.5-3.0 ml of mineral oil to minimize the sample buffer evaporation. Using the PROTEAN® IEF Cell, an active rehydration was performed at 50V and 20° C. for 12-18 hours.

IEF strips were then transferred to a new tray and focused for 20 min at 250V followed by a linear voltage increase to 8000V over 2.5 hours. A final rapid focusing was performed at 8000V until 20,000 volt-hours were achieved. Running the IEF strip at 500V until the strips were removed finished the isoelectric focusing process.

Isoelectric focused strips were incubated on an orbital shaker for 15 min with equilibration buffer (2.5 ml buffer/strip). The equilibration buffer contained 6M urea, 2% SDS, 0.375M HCl, and 20% glycerol, as well as freshly added DTT to a final concentration of 30 mg/ml. An additional 15 min incubation of the IEF strips in the equilibration buffer was performed as before, except freshly added iodoacetamide (C₂H₄INO) was added to a final concentration of 40 mg/ml. The IPG strips were then removed from the tray using clean forceps and washed five times in a graduated cylinder containing the Bio Rad running buffer 1× Tris-Glycine-SDS.

The washed IEF strips were then laid on the surface of Bio Rad pre-cast CRITERION SDS-gels 8-16%. The IEF strips were fixed in place on the gels by applying a low melting agarose. A second dimensional separation was applied at 200V for about one hour. After running, the gels were carefully removed and placed in a clean tray and washed twice for 20 minutes in 100 ml of pre-staining solution containing 10% methanol and 7% acetic acid.

Staining and Analysis of the 2D Gels

Once the 2D gel patterns of the serum samples were obtained, the gels were stained with a fluorescent or colored stain. SYPRO RUBY (Bio-Rad Laboratories) was the preferred stain. Once the protein spots had been stained, the gel was scanned and a digital image of the protein expression profile of the sample was obtained.

The digital image of the scanned gel was processed using PDQUEST (Bio-Rad Laboratories) image analysis software to first locate the selected biomarkers and then to quantitate the protein in each of the selected spots. The scanned image was cropped and filtered to eliminate artifacts using the image editing control. Individual cropped and filtered images were then placed in a matched set for comparison to other images and controls.

This process allowed quantitative and qualitative spot comparisons across gels, the determination of protein biomarker molecular weight and isoelectric point values. Multiple gel images were normalized to allow an accurate and reproducible comparison of spot quantities across two or more gels. The gels were normalized using the “total of all valid spots method” which assumes that few protein spots change between serum samples, and that changes average out across the whole gel. The quantitative amount of the selected biomarkers present in each sample was then exported for further analysis using statistical programs.

The 2D gel patterns of the 92 serum samples collected from normal control subjects were compared with each other. The 92 normal samples all gave similar 2D gel protein patterns. The normal protein expression pattern was then compared to the gel patterns obtained in serum samples of 183 patients diagnosed with a neuromuscular disease. The comparison of the protein expression pattern of normals and neuromuscular patients identified 34 protein spots seen on 2D gels that differed in protein concentration.

The Reproducibility of Biomarker Identification and Quantification

To assess the reproducibility of the 2D gels and staining, 75 nanograms of bovine serum albumin (BSA) was run on 9 separate 2D gels. The gels were stained with SYPRO RUBY and the 5 spots that resulted in the BSA region of the gel were then subjected to quantitative analysis using PDQUEST and the Gaussian Peak Value method. The results illustrated that the electrophoretic patterns were reproducible and independent of the spot amount over the range tested. The relative standard deviations (% CV) obtained with the multiple runs (n=9) of BSA were about 20% over a range of protein concentration.

To characterize the variability in scanning and spot detection, a single gel was scanned 10 times and each image processed, analyzed, and the abundance of a group of 10 selected protein spots quantified. The results demonstrate that there is a high degree of reproducibility with the equipment and software operation over the range of protein concentrations observed for eleven selected protein spots. The relative standard deviations (% CV) obtained with the multiple scans varied from about 3% to 29%. In fact the 5CV was only greater than about 15% on one biomarker spot analyzed.

Selection of the Biomarkers Used in the Assay

Once the 92 normal serum samples and the 183 neuromuscular disease serum samples had been run on 2D gels and the initial 34 identified protein spots were quantitated in each serum sample, the results were analyzed using statistical programs to determine which biomarkers to include in the assay for neuromuscular disease in order for the assay to have a sensitivity, specificity, and positive and negative predictive values to be of clinical use to physicians.

Initially, the mean and standard deviations of the biomarkers were used to select the biomarkers and to assess the statistical significance of concentration differences in the biomarkers between the control sera and the neuromuscular disease sera. However because of the number of biomarkers studied, subsequent studies used multi-variant statistical programs to select the biomarkers. A linear discriminate functional analysis was employed to determine the sensitivity, specificity, positive predictive value (PPV), and negative predictive value (NPV) of each biomarker and a number of combinations of biomarkers in determining the difference between normal serum and serum taken from patients diagnosed with neuromuscular disease.

The 92 normal control samples and the 183 neuromuscular disease samples were initially used as a training set for model building purposes. The sensitivity, specificity, PPV, and NPV for each selected biomarker was determined. The linear discriminate functional analysis of the data indicated that the combination of 7 biomarkers would provide a diagnostic tool for the identification of neuromuscular disease. The analysis showed that each of the 7 selected biomarkers made an independent contribution to the discriminate analysis of serum samples. The 7 selected biomarkers were identified as the protein spots arbitrarily marked 1511, 6519, 1308, 7310, 3209, 9311, and 1506. The neuromuscular disease assay, using the 7 selected biomarkers, as applied to the 92 normal control samples and the 183 neuromuscular disease samples gave a sensitivity of 72%, a specificity of 74%, a PPV of 85%, and a NPV of 57%.

Once the test model had been tested and the assay using the 7 biomarkers established, the quantity of these biomarkers in a smaller test set of samples (i.e., 20 normal sera and 60 neuromuscular disease sera) was used to validate the assay model. An analysis of the test set of sample gave a sensitivity of 73%, a specificity of 65%, a PPV of 81%, and a NPV of 54%.

Optimizing the Assay of Patient Samples for Neuromuscular Disease

Preliminary experiments were performed on the test samples in an effort to maximize the efficacy of the neuromuscular disease assay. The experiments were designed to optimize the reproducibility of biomarker concentration measurements and thereby to increase sensitivity, specificity, PPV, and NPV of the neuromuscular disease assay.

For example, triplicate analyses (i.e., 2D gel electrophoreses and the quantitation of a selected protein spot 3307) of each of 5 normal serum samples and 6 patient serum samples were performed. The three 2D gel images of each sample were compared and the graphical and image analyses were merged to eliminate any misidentification of spots in the gels. The image comparison of the triplicate runs of the serum samples revealed that in 1 of the 5 normal samples and in 2 of the 6 patient samples a single protein spot had been misidentified. Removal of the misidentified spots from the sample analysis enhanced statistical significance of the difference between normal samples and patient samples and reduced the relative standard deviations (% CV) to 23%.

Assay for Neuromuscular Disease

The assay for neuromuscular disease comprises the following steps: (1) collecting a serum sample from a patient; (2) running triplicate 2D gel electrophoreses of the patient sample; (3) staining and comparing the gel images; (4) verifying the identity of the selected protein spots; (5) removing any misidentified protein spot; (6) performing a statistical analysis on the quantity of the selected spots to determine the likelihood of the patient having a neuromuscular disease.

While the methods have been described in terms of preferred embodiments, it will be apparent to those of skill in the art that variations may be applied to the methods including the sequence of steps in the methods. Certain agents may be substituted by one of skill and similar results may be achieved, as will be appreciated by one of skill in the art. Such modifications or substitutions to the methods of the present invention are deemed to be within the spirit, scope and concept of the invention as defined by the disclosure and its claims.

What is claimed is:

1. A screening assay for neuromuscular disease comprising:
a) collecting a serum sample from a patient;
b) performing a two-dimensional (2D) gel electrophoretic analysis of the serum sample;
c) staining the 2D gel pattern;
d) quantitating a set of preselected protein spots; and
e) performing a statistical analysis on the quantity of the selected spots to determine the likelihood of the patient having a neuromuscular disease.
